(19) United States
(12) Patent Application Publication
(10) Pub. No.: US 2014/0051307 A1
(43) Pub. Date: Feb. 20, 2014

(54) TERMINAL FITTING

(71) Applicant: Yazaki Corporation, Tokyo (JP)

(72) Inventors: Hiroshi AOKI, Toyota-shi (JP); Osamu OSHITA, Toyota-shi (JP)

(73) Assignee: Yazaki Corporation, Tokyo (JP)

(21) Appl. No.: 14/062,101

(22) Filed: Oct. 24, 2013

Related U.S. Application Data
(63) Continuation of application No. PCT/JP2012/065290, filed on Jun. 14, 2012.

(30) Foreign Application Priority Data
Jun. 17, 2011 (JP) 2011-135491

(51) Int. Cl. H01R 13/432

(52) U.S. Cl. CPC H01R 13/432
USPC 439/746

(57) ABSTRACT

In a terminal fitting, a lance engaged in a retaining recess in a cavity of a connector housing is arranged to protrude from the outside surface of a terminal body, and the lance is prevented from falling out of the cavity by the engagement of the lance and the retaining recess. The lance is a free end of a belt-form piece which is overlapped on the inner surface of a first outside wall of the terminal body which is raised up along an elastic displacement direction when the lance is engaged in the retaining recess, and which has a predetermined width in the elastic displacement direction and extends in parallel to an insertion direction in which the terminal fitting is inserted into the cavity.

### CROSS REFERENCE TO RELATED APPLICATIONS

This application is a continuation of PCT application No. PCT/JP2012/065290, which was filed on Jun. 14, 2012 based on Japanese Patent Application (No. P2011-135491) filed on Jun. 17, 2011, the contents of which are incorporated herein by reference.

### BACKGROUND OF THE INVENTION

1. Field of the invention

The present invention relates to a terminal fitting whose lance, by which the terminal fitting is prevented from falling out of a cavity of a connector housing, is arranged to protrude from the outside surface of a terminal body.

2. Description of the Related Art

FIG. 5 is a perspective view which shows the construction of a terminal fitting 100 disclosed in JP-A-10-40996.

The terminal fitting 100 includes a terminal body 110 which is formed by press molding a metal plate, and a lance 120 which is arranged to protrude from the outside surface of the terminal body 110.

The terminal body 110 has a terminal engaging part 111 at the front end side. The terminal engaging part 111 has a rectangular pipe shape to which a male terminal which is a connecting counterpart is fitted.

The lance 120 is so formed integrally with the terminal engaging part 111 that the lance 120 may be elastically displaced into the terminal engaging part 111 and protrudes from the outside surface of the terminal engaging part 111.

In particular, the lance 120 in the illustrated example is formed by cutting and raising a part of a first outer wall plate 112 which is an upper side outer wall of the terminal engaging part 111 so that the lance 120 protrudes from the outer surface of the first outer wall plate 112. The lance 120 is a plate piece which obliquely extends from the front end side of the terminal engaging part 111 toward the back end side.

When the terminal fitting 100 in the illustrated example is inserted into a cavity (a terminal insertion hole) of a connector housing (not shown in the figure), the lance 120 enters into a retaining recess formed in the cavity and is prevented from falling out of the cavity.

Techniques in which a retaining lance is formed by a plate piece which is obliquely extended from the front end side of the terminal engaging part toward the back end side are also disclosed in JP-A-2002-280106 and J P-A-2002-93508.

### SUMMARY OF THE INVENTION

However, for the terminal fitting 100 of JP-A-10-40996, when an external force in the direction, in which the terminal fitting 100 is pulled out, is applied on the terminal fitting 100 while the lance 120 is engaged with the retaining recess of the connector housing, as shown in FIG. 5, a load F against the pulling force is applied on the free end of the lance 20.

The load F is a load along an insertion direction in which the terminal fitting 100 is inserted into the connector housing (a fitting direction), as shown in FIG. 6, and since the load F has a component Ft in the plate thickness direction relative to the free end of the lance 120 which is inclined to the insertion direction, the lance 120 is easy to be bended in the plate thickness direction due to the effect of the component Ft. Therefore, there are the following problems. It is difficult to increase the bending stiffness of the lance 120 relative to the load F against the pulling force and it is difficult to increase the fixing force (the retaining force) of the lance to fix the terminal fitting in the connector housing.

Since the lance in JP-A-10-40996 which is a plate piece that is inclined relative to the fitting direction in which the terminal fitting is fitted is commonly used in the cases of the terminal fittings of JP-A-2002-280106 and JP-A-2002-93508, the above problems may also happen like JP-A-10-40996.

Thus, an object of the present invention is to solve the above problems and provide a terminal fitting for which the bending stiffness of a lance relative to a load which is applied onto the lance from a retaining recess when the lance is engaged in the retaining recess of a connector housing can be increased, and the fixing force (the retaining force) of the lance to fix the terminal fitting in the connector housing can be increased.

The above-mentioned object of the invention is achieved by the following constructions.

(1) A terminal fitting comprising:

a terminal body which is formed by press molding a metal plate; and

a lance which is integrally formed with the terminal body so that the lance is capable of being elastically displaced in the terminal body and protrudes from an outside surface of the terminal body;

wherein when the terminal fitting is inserted into a cavity of a connector housing, the lance enters into a retaining recess formed in the cavity to prevent the terminal fitting from falling out of the cavity; and

wherein the lance is a free end of a belt-form piece which is overlapped on an inner surface of a first outside wall of the terminal body which extends in parallel to a direction in which the terminal fitting is inserted into the cavity and which is raised up along an elastic displacement direction of the lance when the lance is engaged in the retaining recess, and which has a predetermined width in the elastic displacement direction and extends along a front-rear direction of the terminal body.

(2) The terminal fitting according to the above (1), wherein the terminal body has a second outside wall which is overlaid on an outer side edge of the belt-form piece to regulate the belt-form piece from being bended or displaced outward.

(3) The terminal fitting according to the above (1) or (2), wherein the free end of the belt-form piece is formed into a laminated two-folded structure by returning an end part of the free end toward a fixed end of the belt-form piece.

(4) The terminal fitting according to the above (1) or (2), wherein at the fixed end of the belt-form piece, joining parts at two sides in a widthwise direction of the belt-form piece where the first outside wall is joined are provided with curved cuts to prevent stress concentration when the belt-form piece is bended in the widthwise direction.

According to the construction of the above (1), the belt-form piece which becomes the lance is folded onto the inner surface of the first outside wall of the terminal body, and extends along the insertion direction in which the terminal fitting is inserted into the cavity. Therefore, when an external force is applied on the terminal fitting in the direction the terminal fitting 1 is pulled out and a load F against the pulling force is applied onto the free end of the lance from the retaining recess, since the load F does not include a component in the plate thickness direction of the lance, the lance is hard to be bended or displaced in the plate thickness direction.

Therefore, when compared to a traditional lance which is arranged to be inclined to the insertion direction in which the terminal fitting is inserted into the cavity, the bending stiffness of the lance relative to the load F against the pulling force can be increased and the fixing force (the retaining force) of the lance to fix the terminal fitting in the connector housing can be increased.

According to the construction of the above (2), even if a pulling load toward the outside of the terminal body is applied on the lance because of disturbance from an external device, since the second outside wall of the terminal body regulates the belt-form piece which becomes the lance from being bended or displaced outward, troubles such as that the lance is bended outward by an external force can be prevented from happening.

According to the construction of the above (3), since the free end of the belt-form piece which becomes the lance and is engaged in the retaining recess of the connector housing is a laminated two-folded structure in which the end part is returned, the mechanical strength of the lance is high. Therefore, the fixing force (the retaining force) of the lance to fix the terminal fitting in the connector housing can be further increased.

According to the construction of the above (4), when the terminal fitting is fitted and installed to the connector housing, the belt-form piece which becomes the lance is bended or displaced toward the terminal body along the widthwise direction of the belt-form piece. When the belt-form piece is bended or displaced, because the internal stress produced in the belt-form piece is intensively applied on the joining parts which are positioned at the two sides in the widthwise direction of the belt-form piece at the fixed end of the belt-form piece, the joining parts may be broken. However, according to the construction of the above (4), the joining parts are provided with the curved cuts so that the stress concentration will be prevented from being produced. Therefore, the joining parts at the fixed end of the belt-form piece can be prevented from being broken, and the durability of the terminal fitting can be improved.

### BRIEF DESCRIPTION OF THE DRAWINGS

FIG. 1 is a longitudinal sectional view which shows that the terminal fitting according to one embodiment of the present invention is accommodated in a cavity of a connector housing.

FIG. 2 is a perspective view of the terminal fitting shown in FIG. 1 which is seen obliquely from above at the front end side.

FIG. 3 is a perspective view which shows an A-A section of FIG. 2.

FIG. 4 is an illustrative view of curved cuts which are formed at joining parts of a belt-form piece and a first outside wall shown in FIG. 3.

FIG. 5 is a perspective view of a traditional terminal fitting.

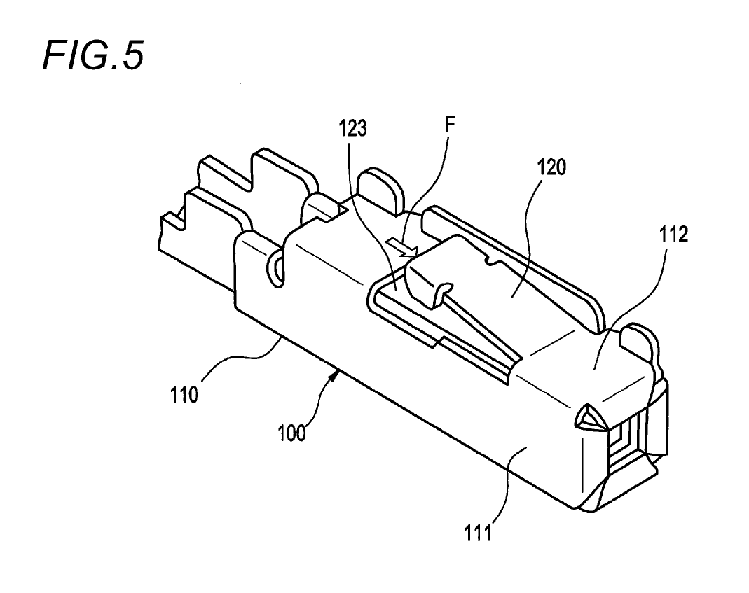

FIG. 6 is an illustrative view which shows that a load component Ft in the plate thickness direction of the lance is applied when a load F from the connector housing is applied on the lance shown in FIG. 5.

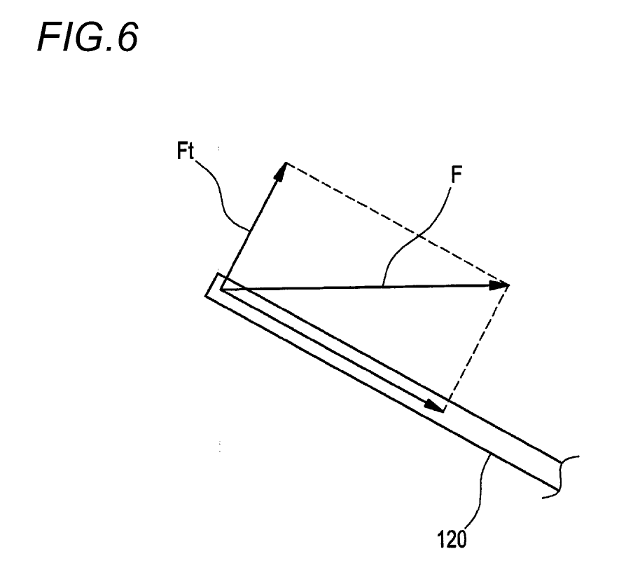

### DETAILED DESCRIPTION OF THE EXEMPLARY EMBODIMENTS A preferred embodiment of the terminal fitting according to the present invention is described in detail with reference to the figures as follows.

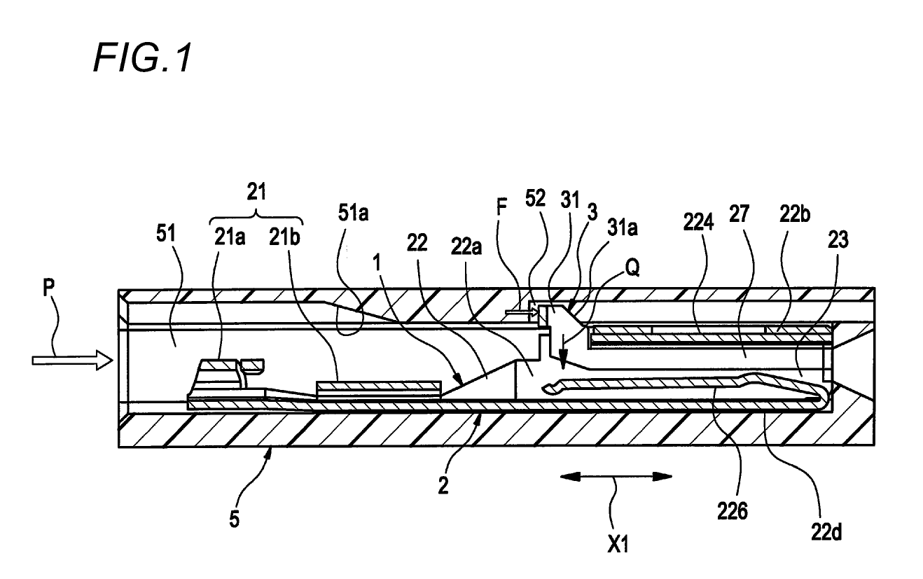

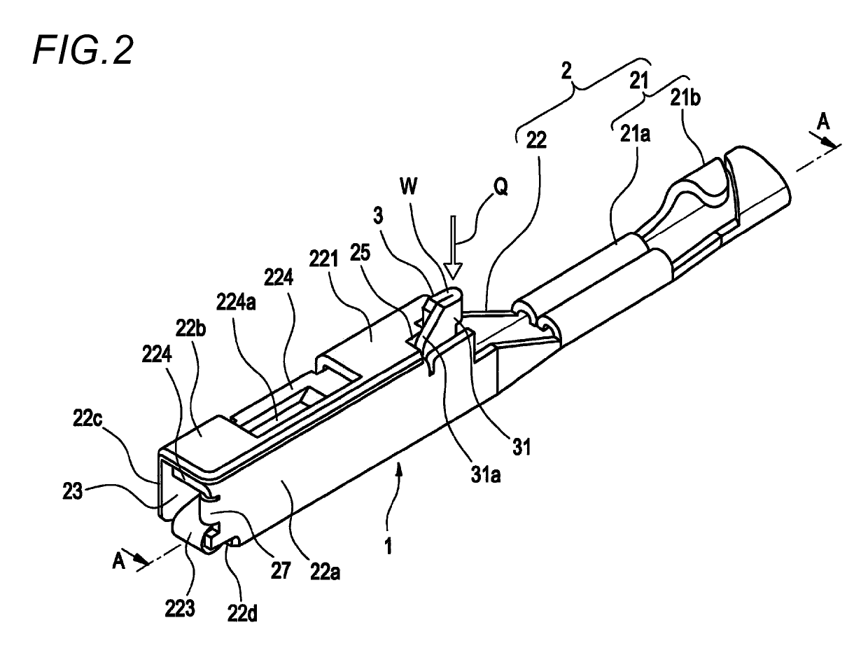

A terminal fitting 1 of the present embodiment is formed by press molding a metal plate and, as shown in FIGS. 1 and 2, includes a terminal body 2 and a lance 3 which is integrally formed with the terminal body 2.

As shown in FIG. 1, the terminal fitting 1 is installed to a connector housing 5 by being inserted into a cavity (terminal insertion hole) 51 of the connector housing 5. When the terminal fitting 1 is inserted into the cavity 51 appropriately, the lance 3 on the terminal body 2 enters into a retaining recess 52 formed in the cavity 51 and is engaged with the retaining recess 52. Since the lance 3 is engaged with the retaining recess 52, the terminal fitting 1 is prevented from falling out. An arrow P in FIG. 1 shows a direction in which the terminal fitting 1 is inserted into the cavity 51.

The lance 3 will be described in detail after the construction of the terminal body 2 is described.

The terminal body 2, as shown in FIG. 2, includes an electric wire crimping part 21 and a terminal engaging part 22.

The electric wire crimping part 21 is a part by which an end of an electric wire (not shown in the figure) is crimped and connected, and includes a conductor crimping piece 21a by which the conductor of the electric wire is crimped and a coating fixing part 21b which is crimped onto the jacket of the electric wire to fix the electric wire.

The terminal engaging part 22 is a part to which a male terminal which is a connecting counterpart is fitted. The terminal engaging part 22 is formed to be a rectangular pipe shaped structure in which a terminal insertion part 23 into which the male terminal is inserted is surrounded by four outside walls, which are a first to a fourth outside walls 22a, 22b, 22cand 22d.

Among the four outside walls, which are the first to the fourth outside walls 22a, 22b, 22c and 22d, the first outside wall 22a is a plate which is a right side outside wall that covers the right side of the terminal insertion part 23 when seen from the front of the terminal, as shown in FIG. 2, and is raised up along an elastic displacement direction Q in which the lance 3 is elastically displaced when the lance 3 is engaged in the retaining recess 52. The second outside wall 22b is a plate which is an upper side outside wall that covers the upper side of the terminal insertion part 23 when seen from the front of the terminal, the third outside wall 22c is a plate which is a left side outside wall that covers the left side of the terminal insertion part 23 when seen from the front of the terminal and the fourth outside wall 22d is a plate which is a lower side outside wall that covers the lower side of the terminal insertion part 23 when seen from the front of the terminal.

In the present embodiment, when the four outside walls 22a, 22b, 22c and 22d are seen from the front side of the terminal fitting 1, the first outside wall 22a is an outside wall connected with the right side edge of the fourth outside wall 22d, the third outside wall 22c is an outside wall connected with the left side edge of the fourth outside wall 22d, and the second outside wall 22b is an outside wall connected with the upper side edge of third outside wall 22c.

Therefore, although not shown in the figure, when a metal plate is punched into an unfolded form of the terminal fitting 1, the terminal engaging part 22 is punched into an unfolded form sequentially with the first outside wall 22a, the fourth outside wall 22d, the third outside wall 22c and the second outside wall 22b in the terminal widthwise direction.

In the present embodiment, an outer surface 221 of the second outside wall 22b of the terminal engaging part 22 is equivalent to an outside surface of the terminal body 2 from which the lance 3 protrudes outward. The second outside wall 22b of the terminal engaging part 22 is provided with a lance opening 25. The lance opening 25 is a rectangular cut through which the lance 3 to be described later may be movably inserted outward.

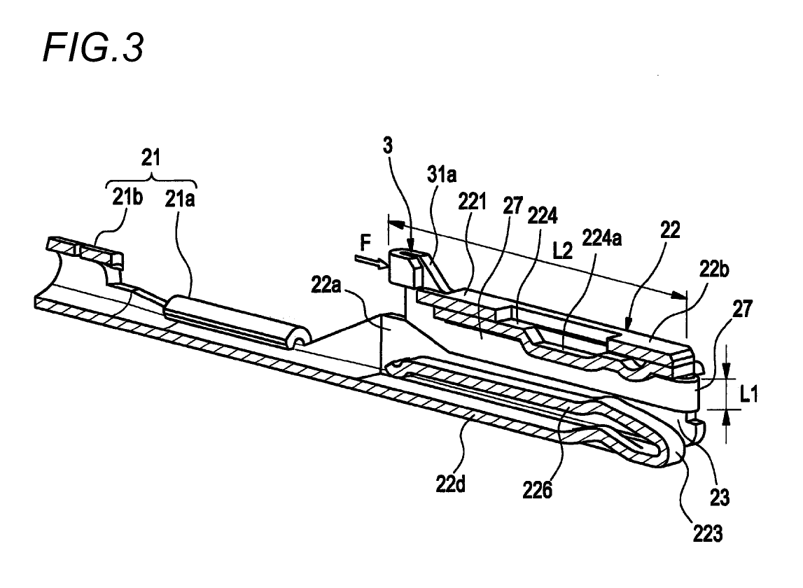

As shown in FIG. 3, a spring supporting part 223 is integrally formed with the fourth outside wall 22d of the terminal body 2, and a terminal contacting plate 224 and a belt-form piece 27 are integrally formed with the first outside wall 22a.

The spring supporting part 223 is provided at the front end of the fourth outside wall 22d. As shown in FIGS. 1 and 3, a spring strip 226 is adjacently provided to the spring supporting part 223. The spring strip 226, as shown in FIGS. 1 and 3, is a plate spring which is arranged to extend in a front-rear direction (an arrow X1 direction as shown in FIG. 1) in the terminal insertion part 23, and is electrically connected to the male terminal which is inserted into the terminal insertion part 23 and which is clamped between the spring strip 226 and the terminal contacting plate 224 to be described later.

The terminal contacting plate 224, as shown in FIGS. 2 and 3, is a plate material that extends from the upper end edge of the first outside wall 22a and is arranged to be laminated on the inner side of the second outside wall 22b by being bended. As shown in FIGS. 2 and 3, the terminal contacting plate 224 is press-molded with a projecting part 224a which protrudes toward the spring strip 226. The projecting part 224a is a part which, together with the spring strip 226, clamps the male terminal to increase the contacting performance with the male terminal.

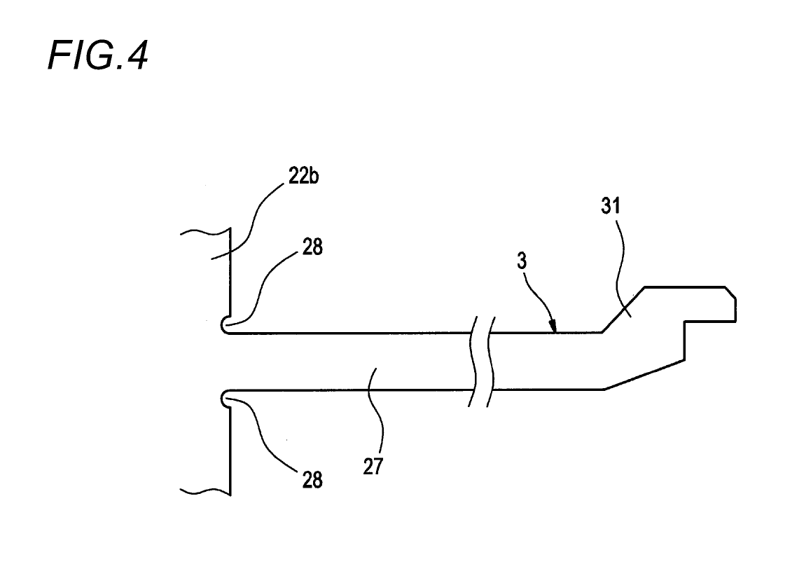

The belt-form piece 27 is a belt-form piece which extends along the direction P (refer to FIG. 1), in which the terminal fitting 1 is inserted into the cavity 51, from the front end of the first outside wall 22a. When the metal plate is punched into the unfolded form of the terminal fitting 1, the belt-form piece 27 is a belt which extends straightly forward from the front end of the first outside wall 22a (refer to FIG. 4). After the punching, the belt-form piece 27 is arranged to be folded onto the inner surface of the first outside wall 22a by being returned to the back surface side of the first outside wall 22a.

While the belt-form piece 27, as shown in FIG. 3, is arranged to be folded onto the inner surface (back surface) of the first outside wall 22a, the belt-form piece 27 is provided to have a predetermined width L1 along the elastic displacement direction Q (refer to FIG. 2), and extend across a predetermined length L2 along the front-rear direction (the arrow X1 direction as shown in FIG. 1) of the terminal body 2. The belt-form piece 27 functions as the lance 3 because a protruding part 31 is formed at the free end.

The protruding part 31 is a part which is engaged in the retaining recess 52 to be prevented from falling out, and passes through the lance opening 25 of the second outside wall 22b to protrude from the outer surface 221 of the second outside wall 22b.

Since the lance 3 of the present embodiment is formed into a structure which is provided with the protruding part 31 at the free end of the belt-form piece 27 which is extended in parallel to the insertion direction P in which the terminal fitting 1 is inserted into the cavity 51, when defined by shape, the lance 3 is provided to be folded onto the inner surface of the first outside wall 22a which extends in parallel to the insertion direction P in which the terminal fitting 1 is inserted into the cavity 51 and is raised up along the elastic displacement direction in which the protruding part 31 is elastically displaced when the protruding part 31 is engaged in the retaining recess 52. The lance 3 is so formed integrally with the terminal body 2 that the protruding part 31 may be elastically displaced in the terminal body 2, and the protruding part 31 protrudes by a predetermined length from the outer surface 221 which is the outer side surface of the terminal body 2 when the protruding part 3 is not elastically displaced.

As shown in FIG. 1, an inclined surface 31a is formed at the front end side of the protruding part 31. Since the inclined surface 31a is collided with an inclined bulged part 51a in the cavity 51 when the terminal fitting 1 is inserted into the cavity 51, the inclined surface 31a receives a force along the elastic displacement direction Q as shown in FIG. 2 from the bulged part 51a and the belt-form piece 27 is easily bended or displaced in the elastic displacement direction Q when the lance 3 is engaged in the retaining recess 52.

The bending stiffness along the elastic displacement direction Q (refer to FIG. 2) of the lance 3 of the present embodiment can be arbitrarily adjusted by appropriately choosing the width L1, the length L2 along the insertion direction P in which the terminal fitting 1 is inserted into the cavity 51, and the plate thickness, as shown in FIG. 3.

In the case of the lance 3 of the present embodiment, as shown in FIG. 2, the protruding part 31 which is at the free end of the belt-form piece 27 is formed into a laminated two-folded structure W by folding an end of the protruding part 31 toward the fixed end (the front end side of the first outside wall 22a) of the belt-form piece 27.

In the case of the lance 3 of the present embodiment, when the metal plate is punched into the unfolded form, at the fixed end of the belt-form piece 27, as shown in FIG. 4, curved cuts 28 are provided at the joining parts which connect the first outside wall 22a at two sides in the widthwise direction of the belt-form piece 27. The curved cuts 28 are cuts by which stress concentration which is produced when the belt-form piece 27 is bended in the widthwise direction is prevented, and are also effective even if the bending deformation in the widthwise direction of the belt-form piece 27 is increased.

In the case of the terminal fitting 1 of the present embodiment, the second outside wall 22b of the terminal body 2, as shown in FIG. 1, is overlaid on the outer side edge (the upper edge in FIG. 1) of the belt-form piece 27 to regulate the belt-form piece 27 from being bended or displaced outward (in FIG. 1, upward).

For the terminal fitting 1 of the present embodiment described above, the belt-form piece 27 which becomes the lance 3 is folded onto the inner surface of the first outside wall 22a of the terminal body 2, and extends along the insertion direction P in which the terminal fitting 1 is inserted into the cavity 51. Therefore, when an external force is applied on the terminal fitting 1 in the direction the terminal fitting 1 is pulled out and the load F (refer to FIG. 1) against the pulling force is applied onto the free end of the lance 3 from the retaining recess 52, since the load F does not include a component in the plate thickness direction of the lance 3, the lance 3 is hard to be bended or displaced in the plate thickness direction.

Therefore, when compared to a traditional lance which is arranged to be inclined to the insertion direction P in which the terminal fitting 1 is inserted into the cavity 51, the bending stiffness of the lance 3 relative to the load F against the pulling force can be increased and the fixing force (the retaining force) of the lance 3 to fix the terminal fitting 1 in the connector housing 5 can be increased.

For the terminal fitting 1 of the present embodiment described above, even if a pulling load toward the outside of the terminal body 2 is applied on the lance 3 because of disturbance from an external device, as shown in FIG. 1, since the second outside wall 22b of the terminal body 2 regulates the belt-form piece 27 which becomes the lance 3 from being bended or displaced outward, troubles such as that the lance 3 is bended outward by an external force can be prevented from happening.

Furthermore, for the terminal fitting 1 of the present embodiment described above, since the free end of the belt-form piece 27 which becomes the lance 3 and is engaged in the retaining recess 52 of the connector housing 5 is a laminated two-folded structure in which the end part is returned, the mechanical strength of the lance 3 is high. Therefore, the fixing force (the retaining force) of the lance 3 to fix the terminal fitting 1 in the connector housing 5 can be further increased.

For the terminal fitting 1 described above, when the terminal fitting 1 is fitted and installed to the connector housing 5, the belt-form piece 27 which becomes the lance 3 is bended or displaced toward the terminal body 2 along the widthwise direction of the belt-form piece 27. When the belt-form piece 27 is bended or displaced, because the internal stress produced in the belt-form piece 27 is intensively applied on the joining parts which are positioned at the two sides in the widthwise direction of the belt-form piece 27 at the fixed end of the belt-form piece 27, the joining parts may be broken. However, for the terminal fitting 1 of the present embodiment described above, as shown in FIG. 4, the joining parts at the fixed end of the belt-form piece 27 are provided with the curved cuts 28 so that the stress concentration will be prevented from being produced. Therefore, the joining parts at the fixed end of the belt-form piece 27 can be prevented from being broken, and the durability of the terminal fitting 1 can be improved.

The terminal fitting of the present invention is not limited to the terminal fitting 1 of the embodiment described previously, and it is possible to make appropriate transformation, improvement or the like.

For example, in the embodiment described previously, the belt-form piece 27 which becomes the lance 3 is a belt that extends from the front end of the outside wall of the terminal body 2 to the rear end side, but it is also possible that the belt-form piece 27 is a belt that extends from the rear end of the outside wall of the terminal body 2 to the front end side.

In the embodiment described above, the free end of the belt-form piece 27 is a laminated two-folded structure in which the end part is returned, but the belt-form piece 27 may be a one-fold structure in which the end part is not returned, particularly when there is no concern in strength.

According to the terminal fitting of the present invention, the belt-form piece which becomes the lance is folded onto the inner surface of the first outside wall of the terminal body, and extends along the insertion direction in which the terminal fitting is inserted into the cavity. Therefore, when an external force is applied on the terminal fitting in the direction the terminal fitting 1 is pulled out and a load F against the pulling force is applied onto the free end of the lance from the retaining recess, since the load F does not include a component in the plate thickness direction of the lance, the lance is hard to be bended or displaced in the plate thickness direction.

Therefore, when compared to a traditional lance which is arranged to be inclined to the insertion direction in which the terminal fitting is inserted into the cavity, the bending stiffness of the lance relative to the load F against the pulling force can be increased and the fixing force (the retaining force) of the lance to fix the terminal fitting in the connector housing can be increased.

What is claimed is:

1. A terminal fitting comprising:
a terminal body which is formed by press molding a metal plate; and
a lance which is integrally formed with the terminal body so that the lance is capable of being elastically displaced in the terminal body and protrudes from an outside surface of the terminal body;
wherein when the terminal fitting is inserted into a cavity of a connector housing, the lance enters into a retaining recess formed in the cavity to prevent the terminal fitting from falling out of the cavity; and
wherein the lance is a free end of a belt-form piece which is overlapped on an inner surface of a first outside wall of the terminal body which extends in parallel to a direction in which the terminal fitting is inserted into the cavity and which is raised up along an elastic displacement direction of the lance when the lance is engaged in the retaining recess, and which has a predetermined width in the elastic displacement direction and extends along a front-rear direction of the terminal body.

2. The terminal fitting according to claim 1, wherein the terminal body has a second outside wall which is overlaid on an outer side edge of the belt-form piece to regulate the belt-form piece from being bended or displaced outward.

3. The terminal fitting according to claim 1, wherein the free end of the belt-form piece is formed into a laminated two-folded structure by returning an end part of the free end toward a fixed end of the belt-form piece.

4. The terminal fitting according to claim 1, wherein at the fixed end of the belt-form piece, joining parts at two sides in a widthwise direction of the belt-form piece where the first outside wall is joined are provided with curved cuts to prevent stress concentration when the belt-form piece is bended in the widthwise direction.
